(19) United States
(12) Patent Application Publication
(10) Pub. No.: US 2007/0113051 A1
(43) Pub. Date: May 17, 2007

(54) Apparatus and method for live loading of control applications in a process control environment

(75) Inventor: Pekka M. Salpakari, Varkaus (FI)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/252,183

(22) Filed: Oct. 17, 2005

(51) Int. Cl. G05B 15/00

(52) U.S. Cl. 712/210; 700/1

(57) ABSTRACT

A method includes identifying one or more data elements common to both a first version of a class and a second version of a class. The first version of the class is associated with at least one first function block. The method also includes automatically generating program code for transferring one or more data values of the one or more data elements from the at least one first function block to at least one second function block associated with the second version of the class. In addition, the method includes executing the program code to transfer the one or more data values from the at least one first function block to the at least one second function block. The data elements common to both versions of the class may be identified using .NET reflection. The program code may be generated using .NET local assembly building.

### CROSS-REFERENCE TO RELATED APPLICATIONS

This application is related to the following U.S. Patent Applications:
Ser. No. 11/175,848 entitled “DETERMINISTIC RUNTIME EXECUTION ENVIRONMENT AND METHOD” filed on Jul. 6, 2005; and
Ser. No. 11/175,703 entitled “APPARATUS AND METHOD FOR DETERMINISTIC GARBAGE COLLECTION OF A HEAP MEMORY” filed on Jul. 6, 2005;
both of which are hereby incorporated by reference.

### TECHNICAL FIELD

This disclosure relates generally to control systems and more specifically to an apparatus and method for live loading of control applications in a process control environment.

### BACKGROUND

Processing facilities are typically managed using process control systems. Example processing facilities include manufacturing plants, chemical plants, crude oil refineries, and ore processing plants. Motors, catalytic crackers, valves, and other industrial equipment typically perform actions needed to process materials in the processing facilities. Among other functions, the process control systems often manage the use of the industrial equipment in the processing facilities.

In conventional process control systems, various controllers are often used to control the operation of the industrial equipment in the processing facilities. The controllers could, for example, monitor the operation of the industrial equipment, provide control signals to the industrial equipment, and generate alarms when malfunctions are detected.

“Control processes” are often implemented in conventional controllers using “function blocks”. Control processes typically represent processes or functions implemented by the conventional controllers to control the industrial equipment in the processing facilities. Function blocks typically represent objects that perform specific tasks. Any of a wide range of tasks could be represented by the function blocks. A combination of particular function blocks may be used to implement a specific control process in a conventional controller.

Function blocks are typically associated with classes that define the function blocks. In conventional controllers, modifications may need to be made to the classes to alter or improve the tasks performed by the function blocks. However, function blocks often have been created and are currently in use for the classes that are being modified, and new function blocks are needed to implement the modified classes. This typically makes it difficult to update the classes without interfering with the operation of the conventional controllers.

### SUMMARY

This disclosure provides an apparatus and method for live loading of control applications in a process control environment.

In a first embodiment, a method includes identifying one or more data elements common to both a first version of a class and a second version of a class. The first version of the class is associated with at least one first function block. The method also includes automatically generating program code for transferring one or more data values of the one or more data elements from the at least one first function block to at least one second function block. The at least one second function block is associated with the second version of the class. In addition, the method includes executing the program code to transfer the one or more data values from the at least one first function block to the at least one second function block.

In particular embodiments, the one or more data elements common to both versions of the class are identified using .NET reflection. Also, the program code is generated using .NET local assembly building.

In a second embodiment, an apparatus includes at least one memory capable of storing at least one first function block associated with a first version of a class and at least one second function block associated with a second version of the class. The apparatus also includes at least one processor capable of identifying one or more data elements common to both the first version and the second version of the class. The at least one processor is also capable of automatically generating program code for transferring one or more data values of the one or more data elements from the at least one first function block to the at least one second function block. In addition, the at least one processor is capable of executing the program code to transfer the one or more data values from the at least one first function block to the at least one second function block.

In a third embodiment, a computer program is embodied on a computer readable medium and is operable to be executed by a processor. The computer program includes computer readable program code for identifying one or more data elements common to both a first version of a class and a second version of a class. The first version of the class is associated with at least one first function block. The computer program also includes computer readable program code for automatically generating program code for transferring one or more data values of the one or more data elements from the at least one first function block to at least one second function block. The at least one second function block is associated with the second version of the class. In addition, the computer program includes computer readable program code for invoking execution of the program code to transfer the one or more data values from the at least one first function block to the at least one second function block.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example process control system according to one embodiment of this disclosure;

FIG. 2 illustrates an example execution environment according to one embodiment of this disclosure;

FIG. 3 illustrates an example live load mechanism for control applications in a process control environment according to one embodiment of this disclosure; and

FIG. 4 illustrates an example method for live loading of control applications in a process control environment according to one embodiment of this disclosure.

### DETAILED DESCRIPTION OF EXAMPLE EMBODIMENTS

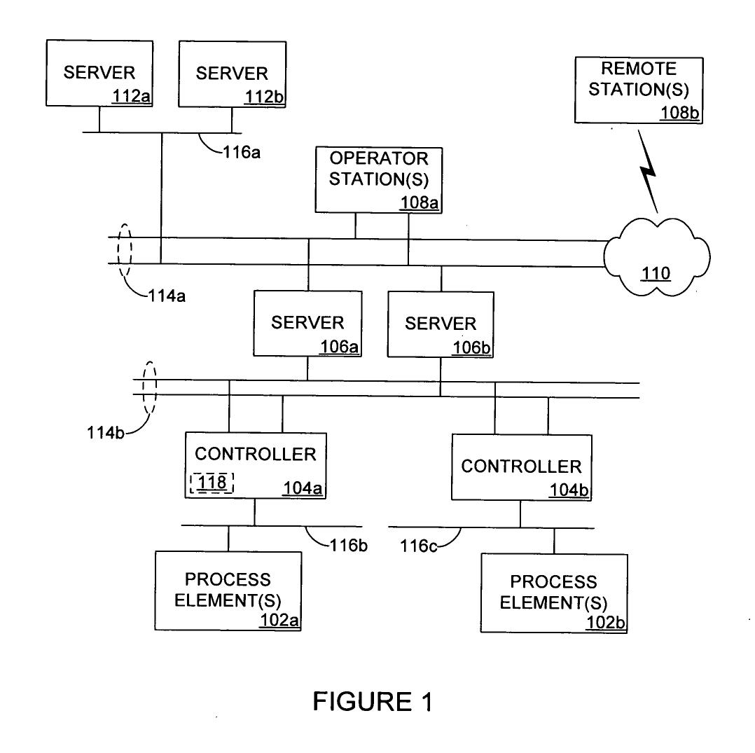

FIG. 1 illustrates an example process control system 100 according to one embodiment of this disclosure. The embodiment of the process control system 100 shown in FIG. 1 is for illustration only. Other embodiments of the process control system 100 may be used without departing from the scope of this disclosure.

In this example embodiment, the process control system 100 includes one or more process elements 102a-102b. The process elements 102a-102b represent components in a processing environment that perform any of a wide variety of functions. For example, the process elements 102a-102b could represent motors, valves, and other industrial equipment in a processing environment. The process elements 102a-102b could represent any other or additional components in a processing environment. Each of the process elements 102a-102b includes any hardware, software, firmware, or combination thereof for performing one or more functions in a processing environment. The process elements 102a-102b could, for example, represent any component, device, or system capable of manipulating, altering, or otherwise processing one or more materials in a processing environment.

Two controllers 104a-104b are coupled to the process elements 102a-102b. The controllers 104a-104b control the operation of the process elements 102a-102b. For example, the controllers 104a-104b could periodically provide control signals to the process elements 102a-102b. Each of the controllers 104a-104b includes any hardware, software, firmware, or combination thereof for controlling one or more process elements 102a-102b. The controllers 104a-104b could, for example, represent C300 controllers. As another example, the controllers 104a-104b could include processors of the POWERPC processor family running the GREEN HILLS INTEGRITY operating system or processors of the X86 processor family running a MICROSOFT WINDOWS operating system.

Two servers 106a-106b are coupled to the controllers 104a-104b. The servers 106a-106b perform various functions to support the operation and control of the controllers 104a-104b and the process elements 102a-102b. For example, the servers 106a-106b could log information collected or generated by the controllers 104a-104b, such as status information related to the operation of the process elements 102a-102b. The servers 106a-106b could also execute applications that control the operation of the controllers 104a-104b, thereby controlling the operation of the process elements 102a-102b. In addition, the servers 106a-106b could provide secure access to the controllers 104a-104b. Each of the servers 106a-106b includes any hardware, software, firmware, or combination thereof for providing access to or control of the controllers 104a-104b. The servers 106a-106b could, for example, represent personal computers (such as desktop computers) executing WINDOWS 2000 from MICROSOFT CORPORATION. As another example, the servers 106a-106b could include processors of the POWERPC processor family running the GREEN HILLS INTEGRITY operating system or processors of the X86 processor family running a MICROSOFT WINDOWS operating system.

One or more operator stations 108a-108b are coupled to the servers 106a-106b. The operator stations 108a-108b represent computing or communication devices providing user access to the servers 106a-106b, which could then provide user access to the controllers 104a-104b and the process elements 102a-102b. For example, the operator stations 108a-108b could allow users to review the operational history of the process elements 102a-102b using information collected by the controllers 104a-104b and servers 106a-106b. The operator stations 108a-108b could also allow the users to adjust the operation of the process elements 102a-102b, controllers 104a-104b, or servers 106a-106b. Each of the operator stations 108a-108b includes any hardware, software, firmware, or combination thereof for supporting user access and control of the system 100. The operator stations 108a-108b could, for example, represent personal computers executing WINDOWS 95, WINDOWS 2000, or WINDOWS NT from MICROSOFT CORPORATION.

In this example, at least one of the operator stations 108b is a remote station. The remote station is coupled to the servers 106a-106b through a remote network 110. The network 110 facilitates communication between various components in the system 100. For example, the network 110 may communicate Internet Protocol (IP) packets, frame relay frames, Asynchronous Transfer Mode (ATM) cells, or other suitable information between network addresses. The network 110 may include one or more local area networks (LANs), metropolitan area networks (MANs), wide area networks (WANs), all or a portion of a global network such as the Internet, or any other communication system or systems at one or more locations.

In this example, the system 100 includes two additional servers 112a-112b. The servers 112a-112b execute various applications to control the overall operation of the system 100. For example, the system 100 could be used in a processing or production plant or other facility, and the servers 112a-112b could execute applications used to control the overall operation of the plant or other facility. As particular examples, the servers 112a-112b could execute applications such as enterprise resource planning (ERP), manufacturing execution system (MES), or any other or additional plant or process control applications. Each of the servers 112a-112b includes any hardware, software, firmware, or combination thereof for controlling the overall operation of the system 100.

As shown in FIG. 1, the system 100 includes various redundant networks 114a-114b and single networks 116a-116c that support communication between components in the system 100. Each of these networks 114a-114b, 116a-116c represents any suitable network or combination of networks facilitating communication between components in the system 100. The networks 114a-114b, 116a-116c could, for example, represent Ethernet networks.

In one aspect of operation, control algorithms are executed by the controllers 104a-104b to control the process elements 102a-102b. The control algorithms are implemented using function blocks 118. The function blocks 118 represent objects that perform specific tasks. A combination of function blocks 118 may be used to implement a specific control algorithm.

Each function block 118 is typically associated with a class that defines the function block 118. For example, the classes typically define data structures for the function blocks 118. The function blocks 118 may be said to represent “instances” of the classes defining the function blocks 118. Also, the current values stored in or associated with the data structure of a function block 118 may be referred to as the current “state” of the function block 118.

Modifications may need to be made to one or more of the classes defining the function blocks 118. For example, a class could be modified by changing the data structure of that class, such as by adding a data element to the data structure of that class. The phrase “data element” refers to any individual unit of data (such as an integer, floating point value, character, or string) or combination of units (such as an array or data structure).

Because one or more instances (function blocks 118) may already exist for the class being modified and new instances (function blocks 118) are needed to implement the modified classes, the controllers 104a-104b support a mechanism for live loading. This mechanism is capable of identifying differences between the data structures of an old version of a class and a new version of a class. This mechanism then transfers data from old function blocks 118 (created using the old version of the class) to new function blocks 118 (created using the new version of the class). This transfer of data may be referred to as a “block state transfer”.

In this way, the live load mechanism is capable of updating new function blocks 118 with the states of old function blocks 118. Moreover, the live load mechanism is capable of taking into account the differences in the data structures of the old and new function blocks 118 when transferring the states. As a result, the live load mechanism provides a way to update a class in a controller without substantially disturbing the execution of the function blocks 118 in the controller.

In some embodiments, the controllers 104a-104b execute, support, or otherwise provide access to an execution environment. The execution environment provides support for various features that managed applications may use during execution. As examples, the execution environment could provide support for mathematical functions, input/output functions, and communication functions. The phrase “managed application” refers to an application executed in the execution environment, where the execution of the application is managed by the execution environment. Managed applications could include programs that use the function blocks 118 to control the process elements 102a-102b.

In particular embodiments, the execution environment used in the controllers 104a-104b to execute the managed applications is deterministic. A deterministic execution environment is an execution environment whose behavior is predictable or that can be precisely specified. The execution environment could be implemented in any suitable manner, such as by using .NET programming based on the Common Language Interface (CLI) specification as ratified by ECMA-335 and support both the Kernel and Compact profiles.

Although FIG. 1 illustrates one example of a process control system 100, various changes may be made to FIG. 1. For example, a control system could include any number of process elements, controllers, servers, and operator stations. Also, FIG. 1 illustrates one operational environment in which the live load mechanism described above could be used. The live load mechanism could be used in any other suitable device or system.

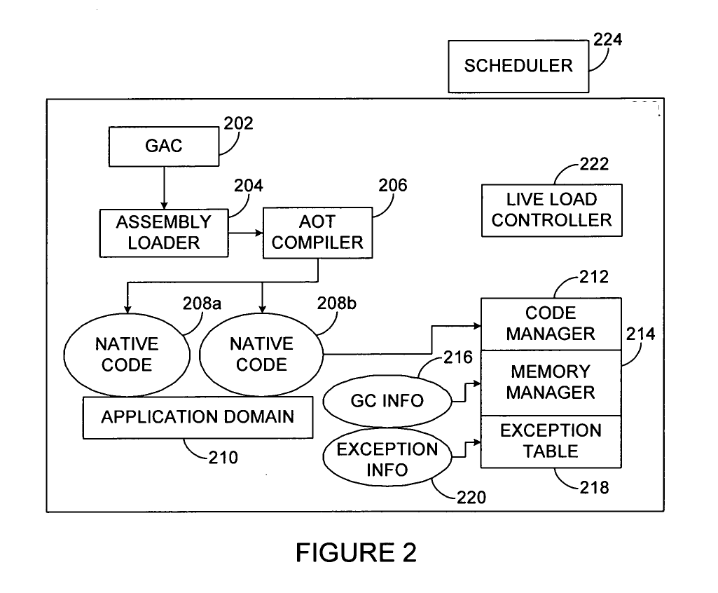

FIG. 2 illustrates an example execution environment 200 according to one embodiment of this disclosure. The embodiment of the execution environment 200 shown in FIG. 2 is for illustration only. Other embodiments of the execution environment could be used without departing from the scope of this disclosure. Also, for ease of explanation, the execution environment 200 is described as being implemented in the controllers 104a-104b of FIG. 1, although the execution environment 200 could be used in any other suitable device or system.

In this example embodiment, the execution environment 200 includes a global assembly cache (GAC) 202. The global assembly cache 202 represents a memory capable of storing different assembly code programs to be executed in the execution environment 200. The assembly code programs could represent the managed applications to be executed in the execution environment 200. As an example, the global assembly cache 202 could store an assembly code program capable of controlling one or more of the process elements 102a-102b of FIG. 1. The global assembly cache 202 could store multiple assembly code programs and/or different versions of the same assembly code program. The global assembly cache 202 represents any suitable storage and retrieval device or devices.

An assembly loader 204 loads assembly code into the execution environment 200 for execution. For example, the assembly loader 204 may retrieve new assembly code downloaded by a user into the global assembly cache 202. The assembly loader 204 may then load the identified assembly code into a compiler for compilation and use in the execution environment 200. The assembly loader 204 includes any hardware, software, firmware, or combination thereof for loading assembly code for compilation. The assembly loader 204 could, for example, represent a software thread executed in the background of the execution environment 200.

An ahead-of-time (AOT) compiler 206 compiles the assembly code loaded by the assembly loader 204. The AOT compiler 206 represents a load-time compiler that compiles assembly code when the assembly code is loaded. For example, the AOT compiler 206 may convert assembly code from an intermediate language to native executable code capable of being executed in the execution environment 200. Also, the AOT compiler 206 could insert instructions into the native executable code to ensure proper execution of the code in the execution environment 200. The AOT compiler 206 includes any hardware, software, firmware, or combination thereof for compiling assembly code. The AOT compiler 206 could, for example, represent a software thread executed in the background of the execution environment 200.

The AOT compiler 206 produces native executable code, such as native executable codes 208a-208b. The native executable codes 208a-208b represent executable code capable of being executed in the execution environment 200. The native executable codes 208a-208b could provide any suitable functionality in the execution environment 200, such as providing control of one or more process elements 102a-102b of FIG. 1. The native executable codes 208a-208b could provide any other or additional functionality in the execution environment 200.

One or more application domains 210 represent the domains in which one or more managed applications (such as the applications implemented by the native executable codes 208a-208b) are executed in the execution domain 200. Each application domain 210 represents any suitable domain for executing one or more managed applications. While shown as a single application domain 210 in FIG. 2, multiple application domains 210 could be used.

The assembly codes and native executable codes in the execution environment 200 are managed by a code manager 212. For example, the code manager 212 may control the loading and unloading of assembly code in the execution environment 200. As a particular example, the code manager 212 could cause the assembly loader 204 to load assembly code into the AOT compiler 206, which generates native executable code that is loaded into the application domain 210. The code manager 212 could also unload native executable code from the application domain 210. The code manager 212 includes any hardware, software, firmware, or combination thereof for managing assembly code and/or compiled code used in the execution environment 200. The code manager 212 could, for example, represent a software thread executed in the background of the execution environment 200.

The execution environment 200 also includes a memory manager 214. The memory manager 214 manages the use of a memory. For example, the memory manager 214 could allocate blocks of memory to managed applications being executed in the application domain 210. The memory manager 214 could also use garbage collection information 216 to release blocks of memory that are no longer being used by the managed applications. The garbage collection information 216 could, for example, be generated by a garbage collection process provided by the memory manager 214 and executed in the background of the execution environment 200. In addition, the memory manager 214 could support a defragmentation process for the memory. The defragmentation process could be used to combine unused blocks of memory into larger blocks. The memory manager 214 includes any hardware, software, firmware, or combination thereof for managing a memory. The memory manager 214 could, for example, represent a deterministic memory manager. The memory manager 214 could also represent a software thread executed in the background of the execution environment 200.

The execution environment 200 further includes an exception table 218, which stores exception information 220. The exception information 220 identifies various problems experienced in the execution environment 200. Example problems could include attempting to load assembly code that does not exist in an explicitly specified location or in the global assembly cache 202, an error during compilation of loaded assembly code, or attempting to unload assembly code not previously loaded. An application or process being executed in the execution environment 200 could generate an exception identifying a detected problem. The exception is identified by the exception information 220, which is stored in the exception table 218 for later use (such as during debugging) or for use by the application or process for automatic recovery at runtime.

In addition, the execution environment 200 includes a live load controller 222. The live load controller 222 supports state transfers from old function blocks 118 (created using old versions of classes) to new function blocks 118 (created using new versions of classes). For example, the live load controller 222 could identify the differences in data structures defined by old and new versions of a class. The live load controller 222 may then automatically generate code for transferring data values from the data structure of the old function blocks 118 into the data structure of the new function blocks 118. The generated code could then be compiled and executed to transfer the data values from the old function blocks 118 to the new function blocks 118. In this document, the term “automatically” and its derivatives refer to partial or total automation of a function or step, even if execution or resumption of the function or step relies on user input (such as user input to initiate automatic generation of the code).

The live load controller 222 or other components in the execution environment 200 may use any suitable technique to identify the differences between data structures, generate code to perform state transfers from old function blocks 118 to new function blocks 118, and compile the code. For example, the live load controller 222 could use a .NET reflection mechanism to identify differences between data structures in old and new versions of a class. The live load controller 222 could also generate the code using a .NET local assembly building mechanism.

The live load controller 222 includes any hardware, software, firmware, or combination thereof for supporting state transfers between function blocks 118. The live load controller 222 could, for example, represent a software thread executed in the background of the execution environment 200.

A scheduler 224 is used to schedule execution of the managed applications. The scheduler 224 may also be used to schedule execution of housekeeping tasks in the execution environment 200. The housekeeping tasks include, among other things, memory management, assembly loading and unloading, and assembly compilation. For example, the scheduler 224 could support time slicing to allow multiple threads to be executed, where the threads represent the housekeeping tasks and the managed applications. The scheduler 224 includes any hardware, software, firmware, or combination thereof for scheduling the execution of applications and other tasks.

In some embodiments, the scheduler 224 and the execution environment 200 cooperate and collaborate to ensure that the managed applications and the housekeeping tasks are executed properly. For example, the scheduler 224 may control when and for how long the housekeeping tasks may be executed in the execution environment 200. As a particular example, the scheduler 224 could preempt all threads executing the managed applications and then call the execution environment 200 to execute one or more housekeeping tasks. The scheduler 224 informs the execution environment 200 of the amount of time available to perform the housekeeping tasks. The execution environment 200 guarantees that control is returned to the scheduler 224 on or before the expiration of that amount of time. While the execution environment 200 is performing a housekeeping task, managed applications that read or write data to a memory may not interrupt the housekeeping task. Other threads that do not access a memory (such as an interrupt service routine or ISR) could be allowed to interrupt a housekeeping task. Averaged over time, the scheduler 224 may provide the execution environment 200 with enough time to perform the housekeeping tasks needed for the managed applications to execute properly. As an example, the managed applications may use up to approximately 80% of the time slices available, while the remaining 20% are used by the housekeeping tasks.

This type of scheduling may impose certain requirements on the managed applications. For example, the managed applications should, over time, allow adequate processing resources to be provided to and used by the housekeeping tasks. Also, a managed application should either come to a “clean point” or use read and write barriers before transferring control to the housekeeping tasks. A “clean point” generally represents a point where a sequence of related instructions being executed for the managed application has been completed, rather than a point that occurs during execution of the sequence of related instructions. As an example, a managed application should complete accessing data in a data structure or file when the transfer of control occurs, rather than being in the middle of reading data or writing data. A read or write barrier is used when the managed application is not at a clean point when the transfer of control occurs. The read or write barrier generally represents a marker or flag used to inform the housekeeping tasks that particular data is currently being used by a managed application. This may prevent the housekeeping tasks from moving the data during defragmentation or discarding the data during garbage collection.

In some embodiments, the various components shown in FIG. 2 operate over a platform/operating system abstraction layer. The platform/operating system abstraction layer logically separates the execution environment 200 from the underlying hardware platform or operating system. In this way, the execution environment 200 may be used with different hardware platforms and operating systems without requiring the execution environment 200 to be specifically designed for a particular hardware platform or operating system.

Although FIG. 2 illustrates one example of an execution environment 200, various changes may be made to FIG. 2. For example, the functional division shown in FIG. 2 is for illustration only. Various components in FIG. 2 could be combined or omitted and additional components could be added according to particular needs.

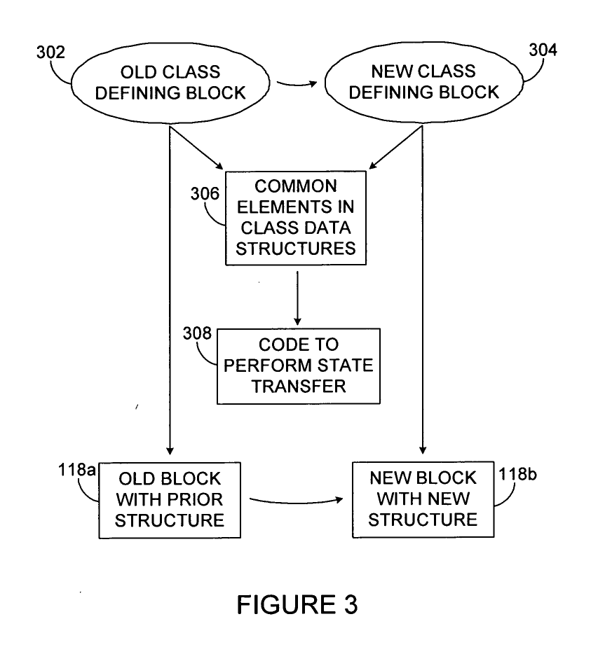

FIG. 3 illustrates an example live load mechanism 300 for control applications in a process control environment according to one embodiment of this disclosure. The live load mechanism 300 shown in FIG. 3 is for illustration only. Other embodiments of the live load mechanism 300 could be used without departing from the scope of this disclosure. Also, for ease of explanation, the live load mechanism 300 of FIG. 3 is described as being implemented in the controller 104a of the system 100 of FIG. 1. The live load mechanism 300 could be used in any other suitable device or system.

As shown in FIG. 3, a class 302 may be used to create one or more function blocks 118a. In this example, the data structure used in the function blocks 118a is defined by the class 302. At some point, a modification is made to the class 302, such as by modifying the data structure defined by the class 302. This leads to the creation of a new class 304. The new class 304 may represent an updated or more recent version of the class 302. Because the old class 302 is modified into the new class 304, the one or more function blocks 118a instantiated using the old class 302 are updated or converted into one or more function blocks 118b. The data structure used in the function blocks 118b is defined by the class 304.

In this example, a set of common data elements 306 within the data structures of the classes 302-304 is identified. The set of common data elements 306 identifies common data elements defined by both classes 302-304. In other words, the set of common data elements 306 represents data elements defined by the old class 302 that are also defined by the new class 304. These data elements represent data elements that have not changed in the new class 304. As a particular example, both classes 302-304 could define an integer named Age. In some embodiments, the .NET reflection mechanism is used to generate the set of common data elements 306. The .NET reflection mechanism is capable of identifying common data elements in two classes (such as classes 302-304).

The set of common data elements 306 is then used to generate code 308. The code 308 represents logic needed to transfer the states of the function blocks 118a into the function blocks 118b. For example, the code 308 could contain an assignment statement for each common data element in the classes 302-304. As a particular example, if both classes 302-304 define an integer named Age, the code 308 could contain an appropriate assignment statement to set the Age integer in the function block 118b equal to the Age integer in the function block 118a. In this way, the code 308 transfers data values from the function blocks 118a to the function blocks 118b. The code 308 is then executed to transfer the data values from the function blocks 118a to the function blocks 118b. In some embodiments, the .NET local assembly building mechanism is used to generate the code 308.

After execution of the code 308, the function blocks 118b contain the same data that is contained in the function blocks 118a. Because of this, the code 308 has transferred the current states of the function blocks 118a to the function blocks 118b. At this point, the function blocks 118b may be used by the controller 104a.

As a particular example, assume class 302 is as follows:

public class A
{

public float x;
public float y;

}

This class 302 defines a public class named “A” with two floating point variables named “x” and “y”. If an instance “b” of class “A” is created, “b” would point to a memory location capable of storing both floating point values. After that, values could be assigned to the variables “x” and “y”.

At some point, the public class “A” could be redefined or modified (creating class 304) as follows:

public class A
{

public float x;
public float y;
public float z;

}

In this example, an additional floating point variable named “z” has been added to class “A”.

When the controller 104a begins using the new class “A,” a new instance “b′” of class “A” may be created. The .NET reflection mechanism is then used to identify the common data elements in the old and new versions of class “A”. For example, the .NET reflection mechanism could determine that “b.x”=“b′.x” and that “b.y”=“b′.y”. In other words, the .NET reflection mechanism determines that both classes define floating point variables named “x” and “y”. These equivalent data elements may be identified in the set of common data elements 306.

Once the common data elements are identified, code 308 is generated to transfer the values of the common data elements. For example, the code 308 could transfer the values of the variables “x” and “y” from the instance “b” to the instance “b′”. As a particular example, the code 308 could implement the following assignment statements:
b′.x=b.x
b′.y=b.y
so that the data values in the instance “b” are copied into the instance “b′”. After compilation and execution of this code 308, the controller 104a could use the instance “b′”, which now contains the data values from the instance “b” as well as storage space for a third floating point value.

One particular mechanism for generating, compiling, and executing the code 308 using .NET local assembly building operates as follows. The .NET local assembly building mechanism uses .NET features such as reflection (as described above) and assembly building to build a temporary class that performs data element copying from an old function block 118 to a new function block 118. Local assembly building may be implemented using the following .NET classes:

System.Reflection.Emit.AssemblyBuilder,
System.Reflection.Emit.ModuleBuilder,
System.Reflection.Emit.MethodBuilder,
System.Reflection.Emit.ILGenerator,
System.Reflection.Emit.TypeBuilder, and
System.Activator.

Using these .NET classes, the creation and execution of local assembly code (code 308) may occur as follows. A new empty assembly program is created using the AssemblyBuilder class. A new module is added to the assembly program using the ModuleBuilder class. A type/class is added to the new module using the TypeBuilder class.

A new method is added to the new type/class in the module using the MethodBuilder class. The new method represents the process to be used to copy data elements from one function block 118 to another function block 118. The method may, for example, be named “copy” and include two arguments that represent pointers to the two function blocks 118 (such as pointers to instance “b” and instance “b′”).

A MICROSOFT Intermediate Language (MSIL) generator is created for the new method using the ILGenerator class. The MSIL generator is used to add lines of code to the new method. For each common data element between the classes 302-304, the MSIL generator adds one or more lines of code implementing an assignment statement for that common data element. The assignment statement is used to copy the value of the common data element from an old function block 118 to a new function block 118. As a particular example, the following MSIL code could be used to transfer the value of a single data element from instance “b” to instance “b′”:

il.Emit (OpCodes.Ldarg,2);
il.Emit (OpCodes.Ldarg,1);
il.Emit (OpCodes.Ldfld,fi1);
il.Emit (OpCodes.Stfld,fi2);

where “fi1” and “fi2” represent data fields identifying a common data element (such as “x” or “y”). The process of adding code to the new method is repeated for each common data element.

Once the new method is complete, the creation of the type/class is finalized using the TypeBuilder class. A temporary instance of the type/class is created using the Activator class, and the new method is called to copy the common data elements from instance “b” to instance “b′”. For example, pointers to instance “b” and instance “b′” may be passed as arguments to the “copy” method. While this represents one possible technique for generating code 308, any other suitable technique could be used.

Although FIG. 3 illustrates one example of a live load mechanism 300 for control applications in a process control environment, various changes may be made to FIG. 3. For example, the same or similar live load mechanism 300 could be used to support modification of any suitable number of classes in a controller or other device.

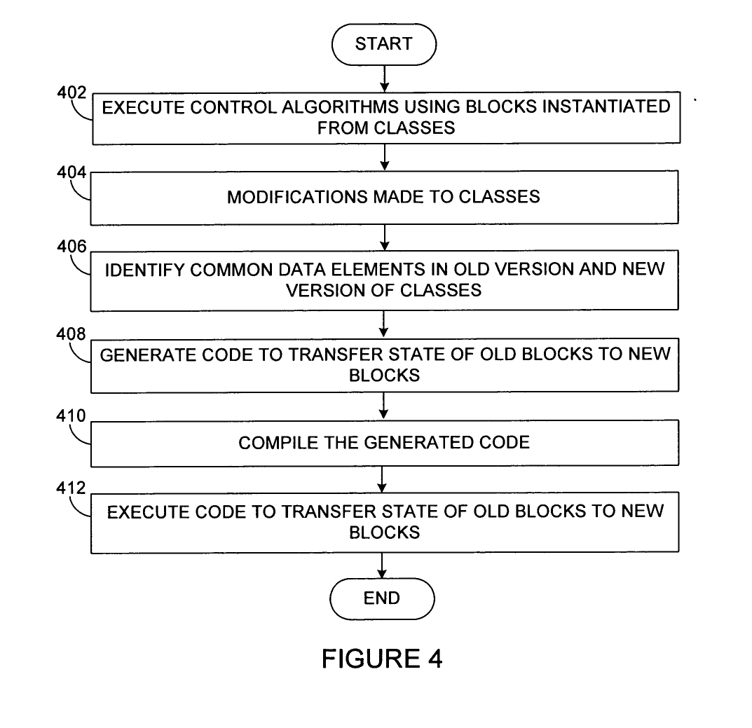

FIG. 4 illustrates an example method 400 for live loading of control applications in a process control environment according to one embodiment of this disclosure. For ease of explanation, the method 400 is described with respect to the controller 104a in the process control system 100 of FIG. 1. The method 400 could be used by any other suitable device and in any other suitable system.

The controller 104a executes one or more control applications at step 402. This may include, for example, the controller 104a executing control algorithms to control one or more process elements 102a in the process control system 100. This may also include the controller 104a executing function blocks 118, which may be used to implement the control algorithms. The function blocks 118 could represent objects instantiated using one or more classes, where the classes define the data structures used in the function blocks 118.

Modifications are made to one or more of the classes at step 404. This may include, for example, a user accessing the controller 104a and changing the definition of a class. This may also include the controller 104a executing logic that changes the definition of a class.

For each modified class, the controller 104a identifies common data elements between the old and new versions of the class at step 406. This may include, for example, the controller 104a using the .NET reflection mechanism to identify the common data elements. The common data elements could be expressed in any suitable manner, such as using MSIL in the set of common data elements 306.

For each modified class, the controller 104a generates code to transfer the state of each old function block (created using the old version of that class) to a new function block (created using the new version of that class) at step 408. The controller 104a then compiles the generated code at step 410. This may include, for example, the controller 104a generating code 308 implementing an assignment statement for each common data element in the old and new versions of the class. This may also include generating the code 308 using the .NET local assembly building mechanism. Native code may be generated from the MSIL code during type finalization or otherwise prior to execution.

The compiled code is executed at step 412. Execution of the compiled code transfers the data values from each old function block 118a to each new function block 118b. This transfers the state of each old function block 118a to each new function block 118b. The new function blocks 118b may then be used by the controller 104a in any suitable manner, such as to continue implementing the one or more control applications being executed.

Although FIG. 4 illustrates one example of a method 400 for live loading of control applications in a process control environment, various changes may be made to FIG. 4. For example, while shown as a sequence of serial steps, various steps in FIG. 4 could be performed in parallel or overlap. Also, FIG. 4 shows a modification being made to a class that is currently used to execute a control application. Any suitable class could be modified to invoke the steps 406-412, even if that class is not currently being used to execute a control application.

In some embodiments, the various functions performed by, within, or in conjunction with the controllers 104a-104b are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, or software, or a combination of at least two of the same. It should be noted that the functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method, comprising:
identifying one or more data elements common to both a first version of a class and a second version of a class, the first version of the class associated with at least one first function block;
automatically generating program code for transferring one or more data values of the one or more data elements from the at least one first function block to at least one second function block associated with the second version of the class; and
executing the program code to transfer the one or more data values from the at least one first function block to the at least one second function block.

2. The method of claim 1, wherein identifying the one or more data elements common to both versions of the class comprises using .NET reflection.

3. The method of claim 1, wherein:
the first version of the class defines a first data structure;
the second version of the class defines a second data structure; and
the one or more data elements common to both versions of the class are defined in both the first data structure and the second data structure.

4. The method of claim 3, wherein the second data structure defined by the second version of the class comprises a modified version of the first data structure defined by the first version of the class.

5. The method of claim 1, wherein generating the program code comprises using .NET local assembly building.

6. The method of claim 5, wherein the program code implements an assignment statement for each of the one or more data elements common to both versions of the class, each assignment statement capable of causing the data value of one data element from the at least one first function block to be copied into the corresponding data element in the at least one second function block.

7. The method of claim 6, wherein automatically generating the program code comprises:
creating a new assembly program;
creating a module in the new assembly program;
creating a type or class in the module;
adding code implementing each assignment statement to a method in the type or class; and
finalizing the type or class;
wherein a temporary instance of the type or class is created and the method in the temporary instance of the type or class is invoked to execute the program code.

8. The method of claim 1, wherein the one or more data elements common to both versions of the class comprise one or more of: an integer, a floating point value, a character, a string, an array, and a data structure.

9. The method of claim 1, wherein the function blocks implement a control application for controlling one or more process elements in a process control system.

10. An apparatus, comprising:
at least one memory capable of storing at least one first function block associated with a first version of a class and at least one second function block associated with a second version of the class; and
at least one processor capable of:
identifying one or more data elements common to both the first version and the second version of the class;
automatically generating program code for transferring one or more data values of the one or more data elements from the at least one first function block to the at least one second function block; and
executing the program code to transfer the one or more data values from the at least one first function block to the at least one second function block.

11. The apparatus of claim 10, wherein:
the first version of the class defines a first data structure;
the second version of the class defines a second data structure; and
the one or more data elements common to both versions of the class are defined in both the first data structure and the second data structure.

12. The apparatus of claim 11, wherein the second data structure defined by the second version of the class comprises a modified version of the first data structure defined by the first version of the class.

13. The apparatus of claim 10, wherein:
the one or more data elements common to both versions of the class are identified using .NET reflection; and
the program code is generated using .NET local assembly building.

14. The apparatus of claim 13, wherein the program code implements an assignment statement for each of the one or more data elements common to both versions of the class, each assignment statement capable of causing the data value of one data element from the at least one first function block to be copied into the corresponding data element in the at least one second function block.

15. The apparatus of claim 14, wherein the program code is generated by:
creating a new assembly program;
creating a module in the new assembly program;
creating a type or class in the module;
adding code implementing each assignment statement to a method in the type or class; and
finalizing the type or class;
wherein a temporary instance of the type or class is created and the method in the temporary instance of the type or class is invoked to execute the program code.

16. A computer program embodied on a computer readable medium and operable to be executed by a processor, the computer program comprising computer readable program code for:
identifying one or more data elements common to both a first version of a class and a second version of a class, the first version of the class associated with at least one first function block;
automatically generating program code for transferring one or more data values of the one or more data elements from the at least one first function block to at least one second function block associated with the second version of the class; and
invoking execution of the program code to transfer the one or more data values from the at least one first function block to the at least one second function block.

17. The computer program of claim 16, wherein:
the first version of the class defines a first data structure;
the second version of the class defines a second data structure; and
the one or more data elements common to both versions of the class are defined in both the first data structure and the second data structure.

18. The computer program of claim 16, wherein:
the computer readable program code for identifying the one or more data elements uses .NET reflection; and
the computer readable program code for generating the program code uses .NET local assembly building.

19. The computer program of claim 18, wherein the program code implements an assignment statement for each of the one or more data elements common to both versions of the class, each assignment statement capable of causing the data value of one data element from the at least one first function block to be copied into the corresponding data element in the at least one second function block.

20. The computer program of claim 19, wherein the program code is generated by:
creating a new assembly program;
creating a module in the new assembly program;
creating a type or class in the module;
adding code implementing each assignment statement to a method in the type or class; and
finalizing the type or class;
wherein a temporary instance of the type or class is created and the method in the temporary instance of the type or class is invoked to execute the program code.
